(19) United States
(12) Patent Application Publication
(10) Pub. No.: US 2010/0185846 A1
(43) Pub. Date: Jul. 22, 2010

(54) COMPUTER PRODUCT, STORAGE DEVICE, AND FIRMWARE MANAGEMENT METHOD

(75) Inventor: Junichi FUKASE, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/689,843

(22) Filed: Jan. 19, 2010

(30) Foreign Application Priority Data
Jan. 20, 2009 (JP) 2009-010027

(51) Int. Cl. G06F 9/48

(52) U.S. Cl. 713/2

(57) ABSTRACT

According to one embodiment, an electronic apparatus includes a plurality of storage modules, a rewrite module, a start module, and a switch module. The storage modules store a plurality of firmware items, respectively. The rewrite module rewrites at least one of the firmware items other than a firmware item being executed with a new firmware item. The start module starts the electronic apparatus with one of the firmware items. The switch module switches, when abnormality is detected in the firmware item for starting the electronic apparatus, the firmware item to another firmware item to start the electronic apparatus.

### CROSS-REFERENCE TO RELATED APPLICATIONS

This application is based upon and claims the benefit of priority from Japanese Patent Application No. 2009-10027, filed on Jan. 20, 2009, the entire contents of which are incorporated herein by reference.

### BACKGROUND

1. Field

One embodiment of the invention relates to a computer product, a storage device, and a firmware management method.

2. Description of the Related Art

In general, storage devices, such as a hard disk drive (HDD), are installed with firmware to control various operations. For example, as illustrated in FIG. 15, the firmware is stored in a nonvolatile memory, such as a flash read only memory (FROM) provided on a printed circuit assembly (PCA) or a system on a chip (SoC), and a system area (SA) on a storage medium. In FIG. 15, a “FROM FW code” indicates the firmware stored in the FROM and a “SA FW code” indicates the firmware stored in the SA.

The firmware may be rewritten due to a system change of the device that is installed with the firmware. In a storage device, when the firmware is rewritten, an erase process and a write process with respect to the FROM and a write process with respect to the SA are performed. In the following, a rewrite process of the firmware in the storage device will be described with reference to FIG. 16. FIG. 16 illustrates a conventional firmware rewrite process.

As illustrated in FIG. 16, the storage device performs processes S1 to S7 using the firmware (Current FW) currently stored in the storage device. First, the storage device downloads new firmware from a host apparatus (S1). If the download is completed, the storage device reproduces the new firmware and verifies validity of data (S2). Then, the storage device writes the new firmware in the SA (S3). If the firmware is completely written in the SA, the storage device unloads a head and turns off a spindle motor (SPM) (S4). Then, the storage device performs an erase process on the FROM (S5), writes new firmware data in the FROM (S6), and performs a reboot process (S7).

Next, as a start process, the storage device copies the new firmware stored in the FROM to the SRAM using a mask read only memory (MROM), and performs an initialization process on a micro processing unit (MPU) or a hard disk controller (HDC) (S8). Next, the storage device performs processes S9 to 513 using the new firmware (New FW) stored in the FROM or the SA. Specifically, the storage device turns on the SPM (S9), loads the new firmware stored in the SA, and verifies validity of data (S10). If the validity of the data is verified, the storage device moves to a main program (S11), loads system data stored in the SA, and verifies validity of the system data (S12). If the validity of the system data is verified, the storage device notifies the host apparatus of a message indicating that download of the new firmware has been completed (S13). Thereby, the rewrite process of the firmware is completed.

In the conventional storage device, only one firmware is stored in each FROM and SA. For this reason, when power supply is stopped or a vibration or shock is received during the rewrite process of the firmware and the rewrite process is failed, the storage device enters in the state where normal firmware is not stored in the FROM or the SA, and the following starts may become impossible (Not Ready state). In this state, since a user cannot access the storage device, it is difficult to recover the data stored in the storage device.

In view of this, a method has been proposed in which old firmware is stored even after firmware is rewritten and a start process is performed using the old firmware when the rewrite is failed.

For example, Japanese Patent Application Publication (KOKAI) No. 2000-39993 discloses a conventional firmware replacing apparatus that comprises two storage areas to store new firmware and old firmware, respectively, a switching circuit to switch between the old firmware and the new firmware, and a timer to clock a monitoring time of the operation of when the new firmware starts. Specifically, the conventional firmware replacing apparatus monitors the operation of when the new firmware starts by the timer for a constant time, and switches the used firmware to the old firmware by the switching circuit, when the abnormal operation is detected. As a result, even when the rewrite of the firmware is failed, the apparatus can start using the old firmware.

For example, Japanese Patent Application Publication (KOKAI) No. 11-328040 discloses a conventional firmware replacing method that provides a flag indicating whether firmware rewrite has been effectively performed in a storage area of each of old firmware and new firmware, and determines the firmware used when a start process is performed by the flag. Specifically, when the rewrite of the firmware is performed, first, a valid/invalid determination flag of the storage area of the new firmware is invalidated and is validated after the rewrite is completed. Then, if a reboot is made and the valid/invalid determination flag of the storage area of the new firmware is validated, a start is made using the new firmware. Meanwhile, if the valid/invalid determination flag of the storage area of the new firmware is invalidated, a start is made using the old firmware stored in the other storage area.

However, the conventional firmware replacing apparatus disclosed in Japanese Patent Application Publication (KOKAI) No. 2000-39993 uses the hardware configuration such as the timer and the switching circuit to switch between the new firmware and the old firmware. This increases a manufacturing cost. In the conventional firmware replacing apparatus, when abnormality is generated during the rewrite of the firmware and the used storage area is switched to another storage area, if abnormality is generated again, the rewrite of the firmware may become failed in both the storage areas, and the following starts may become impossible.

In the conventional firmware replacing method disclosed in Japanese Patent Application Publication (KOKAI) No. 11-328040, when the rewrite of the downloaded firmware starts or is completed, the valid/invalid determination flag is updated. For this reason, if the abnormality is generated during the rewrite process of the firmware, information of the flag may become have an undefined value and an abnormal value may be read. In some cases, the start may be made at the side of the firmware where the rewrite has been failed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary view for explaining a plurality of firmware storage areas according to an embodiment of the invention;

FIG. 1B is an exemplary view for explaining an aspect where only non-executed firmware is rewritten with new firmware in the embodiment;

FIG. 1C is an exemplary view for explaining an aspect where firmware is switched when rewrite of the firmware is failed in the embodiment;

FIG. 2 is an exemplary block diagram of a storage device in the embodiment;

FIG. 3 is an exemplary view for explaining firmware storage areas in the storage device in the embodiment;

FIG. 4 is an exemplary block diagram of an MPU in the embodiment;

FIG. 5 is an exemplary view for explaining an aspect where firmware is rewritten in the embodiment;

FIG. 6 is an exemplary view for explaining a process sequence of when firmware is rewritten in the embodiment;

FIG. 7 is an exemplary view for explaining a process sequence of when the storage device is started in the embodiment;

FIG. 8 is an exemplary view for explaining an aspect where firmware is switched upon start of the storage device in the embodiment;

FIG. 9 is an exemplary view for explaining an aspect where firmware is switched during the process of starting the storage device in the embodiment;

FIG. 10 is a flowchart of a start process in the embodiment;

FIG. 11 is a flowchart of an FROM recovery process in the embodiment;

FIG. 12 is a flowchart of an SA recovery process in the embodiment;

FIG. 13 is a flowchart of a firmware rewrite process in the embodiment;

FIG. 14 is an exemplary view of an electronic apparatus that executes a firmware management program in the embodiment;

FIG. 15 is an exemplary view for explaining firmware storage areas according to a conventional technology; and

FIG. 16 is an exemplary view for explaining a write process of firmware in the conventional technology.

### DETAILED DESCRIPTION

Various embodiments according to the invention will be described hereinafter with reference to the accompanying drawings. In general, according to one embodiment of the invention, a storage device installed with firmware comprises a plurality of storage modules, a rewrite module, a start module, and a switch module. The storage modules are configured to store a plurality of firmware items, respectively. The rewrite module is configured to rewrite at least one of the firmware items other than a firmware item being executed with a new firmware item. The start module is configured to start the storage device with one of the firmware items. The switch module is configured to switch, when abnormality is detected in the firmware item for starting the storage device, the firmware item to another firmware item to start the storage device.

According to another embodiment of the invention, a firmware management method for managing firmware stored in an electronic apparatus comprises: rewriting at least one firmware item other than a firmware item being executed among a plurality of firmware items stored in the electronic apparatus with a new firmware item; starting the electronic apparatus with one of the firmware items; and switching, when abnormality is detected in the firmware item for starting the electronic apparatus, the firmware item to another firmware item to start the electronic apparatus.

According to still another embodiment of the invention, a computer program product comprises a computer usable medium having computer readable program codes embodied in the medium that, when executed, causes a computer to implement the above firmware management method.

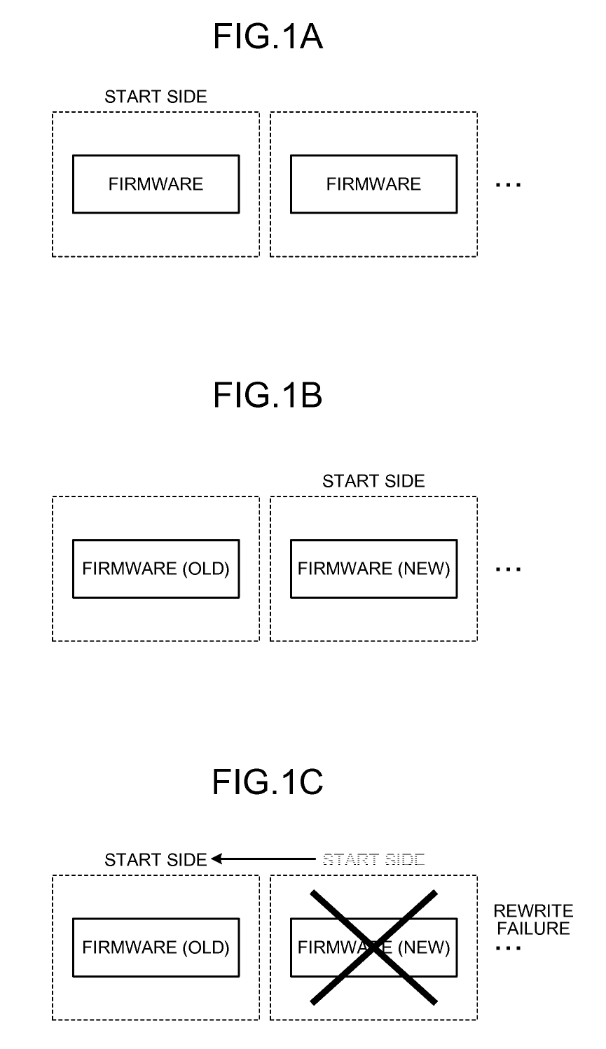

FIG. 1A illustrates an aspect where a plurality of firmware storage areas are provided. FIG. 1B illustrates an aspect where only non-executed firmware is rewritten with new firmware. FIG. 1C illustrates an aspect where the firmware is switched when rewrite of the firmware is failed.

An electronic apparatus, to which is applied a firmware management method of an embodiment of the invention, stores a plurality of firmware items as illustrated in FIG. 1A. The electronic apparatus executes one of the firmware and controls a start process.

When updating the firmware according to an instruction from the host apparatus, the electronic apparatus rewrites at least one of the firmware other than the currently executed firmware with new firmware as illustrated in FIG. 1B. If the rewrite of the firmware is completed, the electronic apparatus starts using the new firmware.

At this time, the electronic apparatus checks whether abnormality is detected in the new firmware. For example, when the abnormality is detected in the new firmware due to rewrite failure of the firmware, the electronic apparatus switches the firmware and starts using the firmware where rewrite is not performed at the time of a rewrite process of the finally executed firmware. Thereby, even when rewrite of the firmware is failed, the electronic apparatus can be prevented from entering in a start disabled state.

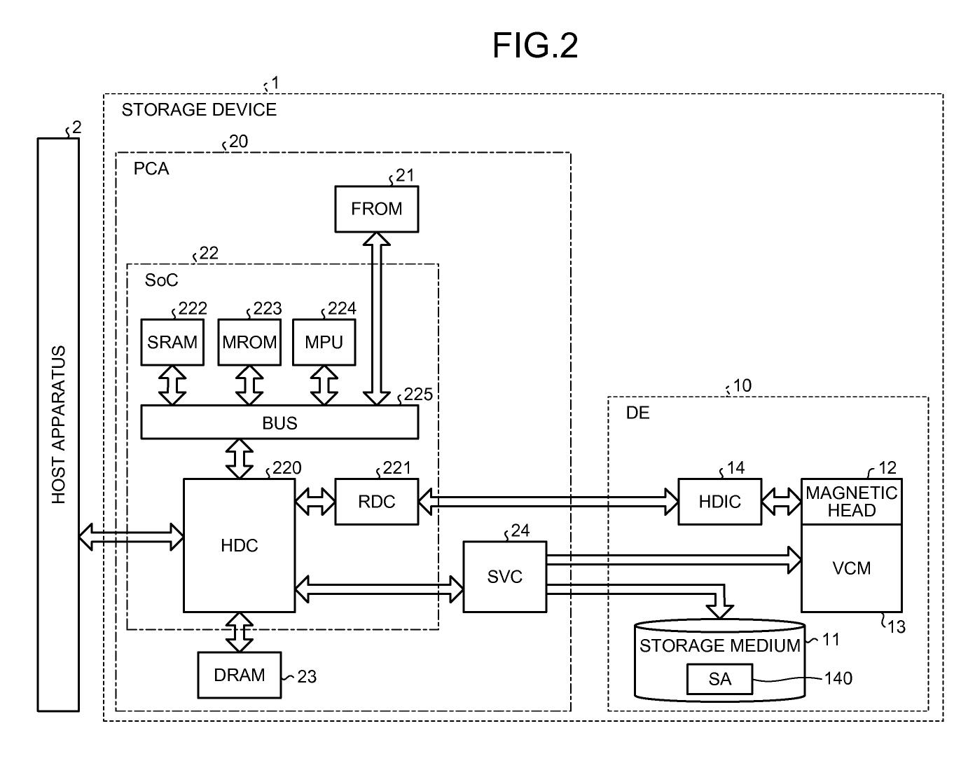

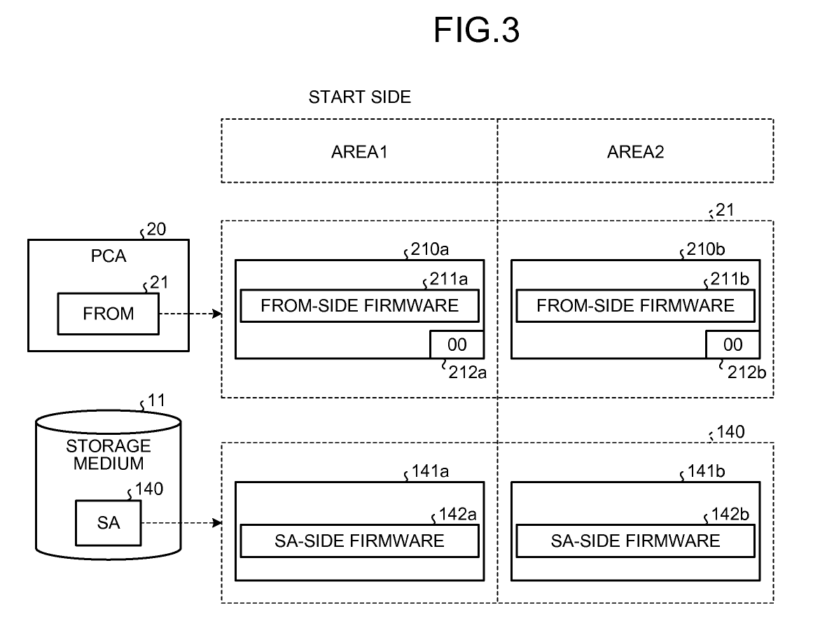

Next, the configuration of the storage device will be described as an example of the electronic apparatus that performs the firmware management method of the embodiment. FIG. 2 is a block diagram of the storage device according to the embodiment. FIG. 3 illustrates firmware storage areas in the storage device of the embodiment. The electronic apparatus that performs the firmware management method is not limited to the storage device, but may be, for example, a home electric appliance such as an electronic oven and a refrigerator, a peripheral device of a personal computer, and a mobile phone, which have an incorporated computer system. The configuration that is not related to the firmware management method of the embodiment is not illustrated or described.

As illustrated in FIG. 2, a storage device 1 of the embodiment comprises a drive enclosure (DE) 10 and a PCA 20. The DE 10 is a casing that accommodates a storage medium, and includes a storage medium 11, a magnetic head 12, a voice coil motor (VCM) 13, and a head integral circuit (HDIC) 14.

The storage medium 11 is a hollow disc-shaped base that has magnetic recording surfaces on front and rear surfaces, and stores a variety of data. In particular, the storage medium 11 has an SA 140 that is an area to store information related to a start of the storage device. The specific configuration of the SA 140 will be descried in detail below. The magnetic head 12 magnetically reads or writes data with respect to the storage medium 11. The VCM 13 is a driving device that moves the magnetic head 12 to a data read/write destination on the storage medium 11. The HDIC 14 amplifies gain of a signal read from the magnetic head 12.

The PCA 20 is a printed board where various large scale integrations (LSI) to control the storage device 1 are disposed. The PCA 20 has a FROM 21, a SoC 22, a dynamic RAM (DRAM) 23, and a servo controller (SVC) 24.

The FROM 21 is a nonvolatile memory that stores firmware to control the operation of the storage device 1. In this case, the storage areas of the firmware in the storage device 1 according to the embodiment will be described. The storage device 1 according to the embodiment has two firmware storage areas in each of the FROM 21 and the SA 140.

Specifically, as illustrated in FIG. 3, the storage device 1 has two storage areas 210a and 210b in the FROM 21 and two storage areas 141a and 141b in the SA 140. FROM-side firmware 211a and 211b are stored in the storage areas 210a and 210b of the FROM 21, and SA-side firmware 142a and 142b are stored in the storage areas 141a and 141b of the SA 140. FIG. 3 illustrates a state of the storage device 1 at the time of shipping from a factory. The FROM-side firmware 211a and 211b are equal to each other and the SA-side firmware 142a and 142b are equal to each other.

The individual storage areas 141a and 141b of the SA 140 correspond to the individual storage areas 210a and 210b of the FROM 21. Specifically, the storage area 141a of the SA 140 corresponds to the storage area 210a of the FROM 21 and the storage area 141b of the SA 140 corresponds to the storage area 210b of the FROM 21. In the description below, as illustrated in FIG. 3, a combination of the storage areas 210a and 141a is assumed as Area1 and a combination of the storage areas 210b and 141b is assumed as Area2. The storage device 1 of the embodiment is provided with a plurality of firmware storage areas in the FROM 21 and the SA 140. The storage areas 210a and 210b of the FROM 21 and the storage areas 141a and 141b of the SA 140 store a plurality of firmware items.

The storage areas 210a and 210b of the FROM 21 store start information 212a and 212b corresponding thereto, respectively. The start information 212a and 212b are used to determine the area and the firmware used at the time of starting the storage device 1.

The SoC 22 is a chip that mounts a main function of the storage device 1. The SoC 22 has a hard disk controller (HDC) 220, a read channel (RDC) 221, a static RAM (SRAM) 222, an MROM 223, an MPU 224, and a bus 225.

The HDC 220 controls the operation of when data stored in the DRAM 23 is written in the storage medium 11 or data recorded in the storage medium 11 is read and stored in the DRAM 23. The RDC 221 is an LSI that intermediates between the DRAM 23 and the storage medium 11 and modulates or demodulates data. The SRAM 222 is a volatile memory to load the firmware stored in the FROM 21. The MROM 223 is a memory that is used by the MPU 224 when the storage device 1 starts, and stores information necessary during a start process.

The MPU 224 controls the overall operation of the storage device 1 using the firmware stored in the FROM 21 or the SA 140 of the storage medium 11. The specific configuration of the MPU will be described in detail below. The bus 225 is a system bus that mutually connects the FROM 21, the HDC 220, the SRAM 222, the MROM 223, and the MPU 224.

The DRAM 23 temporarily stores data read or written between a host apparatus 2 and the DE 10. The SVC 24 supplies a driving current to an SMP (not illustrated) provided in the storage medium 11 or the VCM 13.

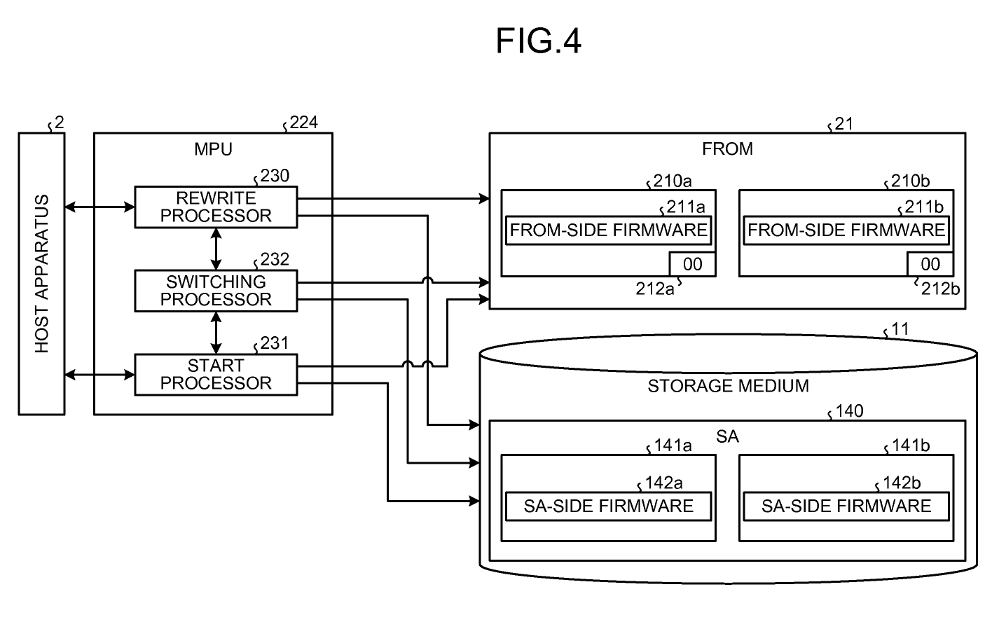

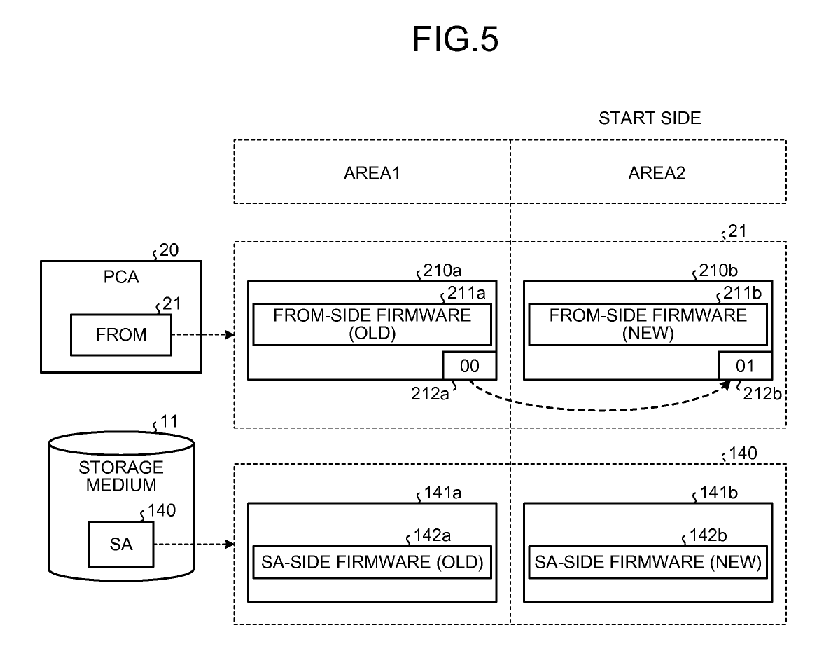

Subsequently, the specific configuration of the MPU 224 of the storage device 1 according to the embodiment will be described with reference to FIG. 4. FIG. 4 is a block diagram of the MPU 224 according to the embodiment. As illustrated in FIG. 4, the MPU 224 comprises a rewrite processor 230, a start processor 231, and a switching processor 232.

The rewrite processor 230 rewrites at least one of the firmware other than the currently executed firmware with new firmware. Specifically, if the rewrite processor 230 receives an update instruction of the firmware from the host apparatus 2, the rewrite processor 230 rewrites FROM-side firmware 211 and SA-side firmware 142, which are stored in the area not being the currently executed area in the Area1 and the Area2, with new firmware.

The start processor 231 starts the storage device 1 using the firmware, where the rewrite is finally performed by the rewrite processor 230, among the firmware. Specifically, the start processor 231 determines to start the storage device 1 using the firmware that belongs to the Area1 or the Area2 based on the start information 212a and 212b stored in the storage areas 210a and 210b of the FROM 21. A rewrite process of the firmware by the rewrite processor 230 and a start process of the storage device 1 by the start processor 231 will be specifically described. FIG. 5 illustrates an aspect where firmware is rewritten.

For example, as illustrated in FIG. 3, in a state where control of the storage device 1 is performed using the firmware (the FROM-side firmware 211a and the SA-side firmware 142a) that belong to the Area1, the storage device 1 receives an update instruction of the firmware from the host apparatus 2. In this case, the rewrite processor 230 rewrites the firmware (the FROM-side firmware 211b and the SA-side firmware 142b), which belong to the Area2 corresponding to the area during the non-execution, with new firmware, as illustrated in FIG. 5. That is, in the storage device 1 according to the embodiment, when the rewrite of the firmware is performed, the rewrite is not performed with respect to the firmware being executed.

If the rewrite of the firmware is normally completed, the rewrite processor 230 updates start information 212 of the area where the rewrite is performed. In this embodiment, the start information 212 is represented by a rewrite count of the firmware. That is, at the time of shipping from the factory, the start information 212a and 212b of the individual areas are “00”. In this state, if the rewrite of the firmware that belongs to the Area2 is performed, the rewrite processor 230 updates the start information 212b of the Area2 from “00” to “01”, as illustrated in FIG. 5. Next, if the rewrite of the firmware is performed in the Area1, the rewrite processor 230 updates the start information 212a of the Area1 from “00” to “02”.

If the rewrite of the firmware is completed, the rewrite processor 230 stores the start information 212, which corresponds to the information related to a rewrite count of the firmware until a point of time when the rewrite is completed, in a storage area 210 of the FROM 21 in the area belonging to the firmware where the rewrite is performed. Thereby, when the rewrite processor 230 updates the start information 212, the rewrite processor 230 may update only the start information of the area where the rewrite of the firmware is performed, and does not need to change or erase the start information of the area where the rewrite of the firmware is not performed.

When the start processor 231 starts the storage device 1, the start processor 231 compares the start information 212a and 212b and performs a start process of the storage device 1 using the firmware belonging to the area where a value of the start information 212 is larger. Thereby, the start processor 231 can start the storage device 1 using new firmware. As illustrated in FIG. 3, when the values of the start information 212a and 212b of the Area1 and the Area2 are equal to each other (at the time of shipping from the factory), the start processor 231 performs a start process using the FROM-side firmware 211a and the SA-side firmware 142a that are the firmware of the Area1.

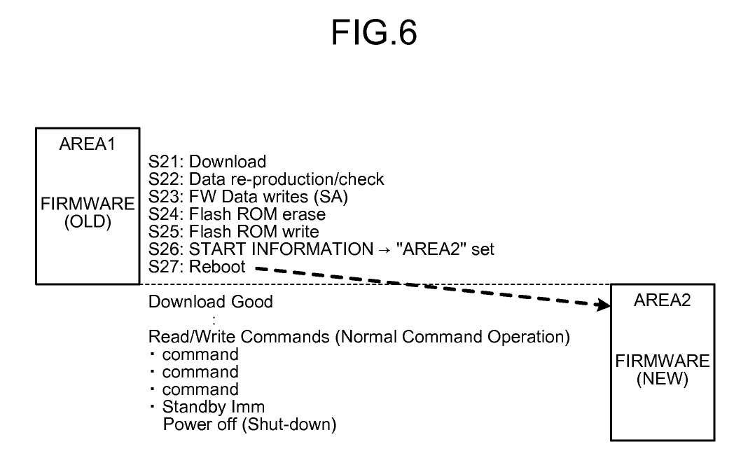

A specific process sequence of when the firmware is rewritten by the rewrite processor 230 will now be described with reference to FIG. 6. FIG. 6 illustrates a process sequence of when the firmware is rewritten.

As illustrated in FIG. 6, the rewrite processor 230 performs the processes S21 to S27 using the currently executed firmware. First, the rewrite processor 230 downloads new firmware from the host apparatus 2 (S21). If the download is completed, the rewrite processor 230 reproduces the new firmware and verifies validity of data (S22). Next, the rewrite processor 230 rewrites the new firmware in the storage area 141b of the SA 140 in the Area2 (S23). If the rewrite is completed, the rewrite processor 230 performs an erase process of the storage area 210b of the FROM 21 in the Area2 (S24), and writes the new firmware in the storage area 210b (S25). The rewrite processor 230 updates the start information 212b of the Area2 from “0” to “1” (S26). If the process is completed, the rewrite processor 230 performs a reboot process (S27). Thereby, the firmware that is not currently executed and belongs to the Area2 is rewritten with new firmware.

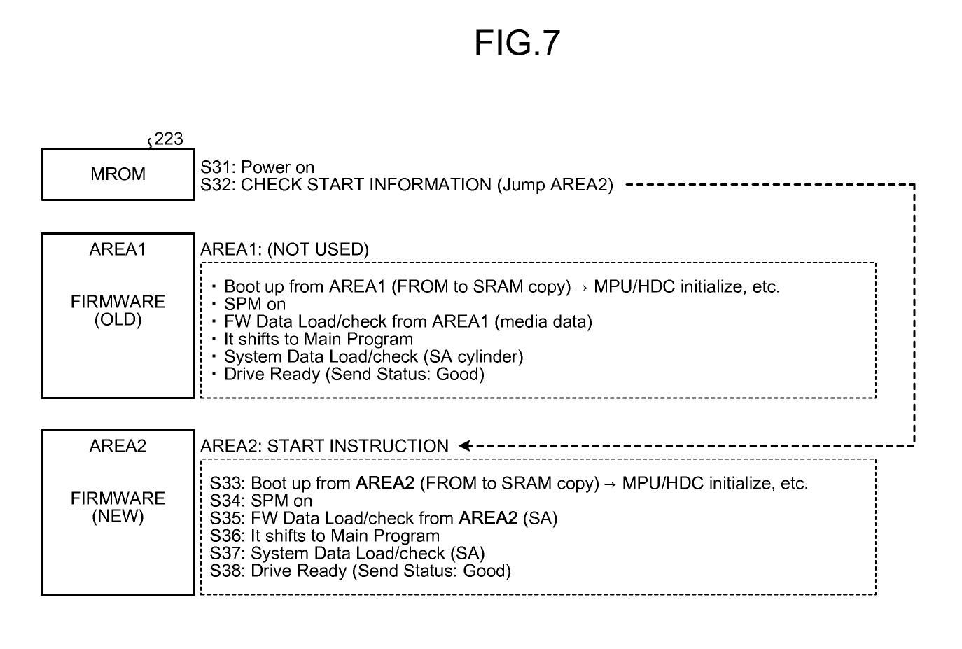

A specific process sequence of when the start processor 231 starts the storage device 1 will now be described with reference to FIG. 7. FIG. 7 illustrates a process sequence of when the storage device 1 starts.

As illustrated in FIG. 7, first, the start processor 231 performs the processes S31 and S32 using the MROM 223. Specifically, if the storage device 1 is turned on (S31), the start processor 231 checks start information of each area (S32). At this time, the start processor 231 determines values of the start information, and determines to start the storage device 1 using the firmware belonging to the Area2 whose information has a large value. Next, the start processor 231 performs the processes S33 to S38 using the firmware belonging to the Area2. That is, the start processor 231 copies the FROM-side firmware 211b, which is stored in the storage area 210b of the FROM 21 in the Area2, to the SRAM 222, and performs an initialization process of the MPU 224 or the HDC 220 (S33).

Next, the start processor 231 turns on the SPM (S34), loads the SA-side firmware 142b stored in the storage area 141b of the SA 140 in the Area2, and verifies validity of data (S35). If the validity of the data is confirmed, the start processor 231 moves to a main program (S36), loads system data stored in the SA 140, and verifies validity of the system data (S37). If the validity of the system data is recognized, the start processor 231 notifies the host apparatus of a message indicating that the start process is completed (S38).

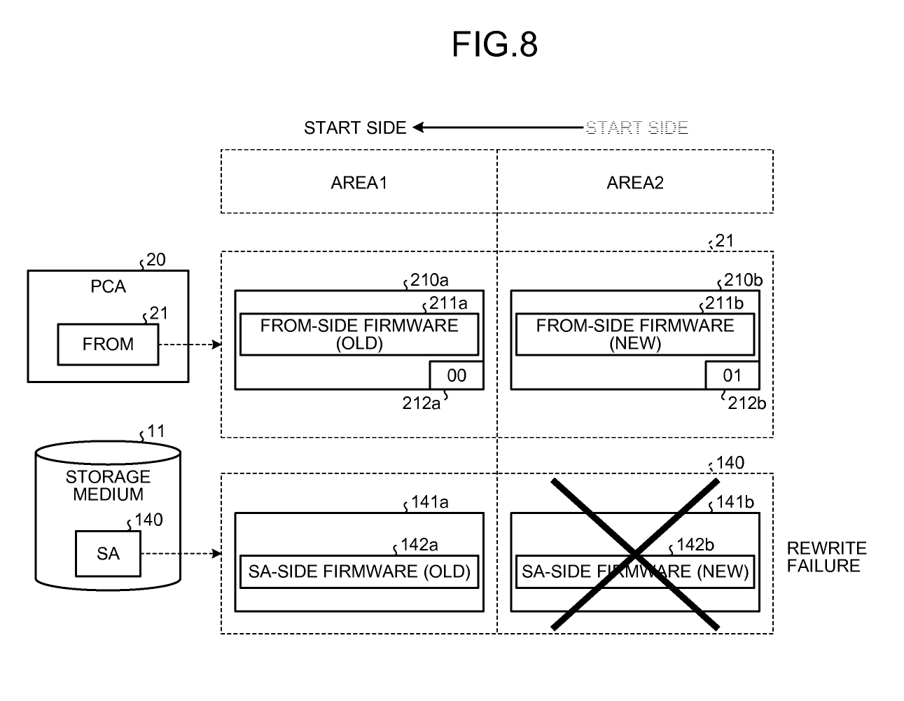

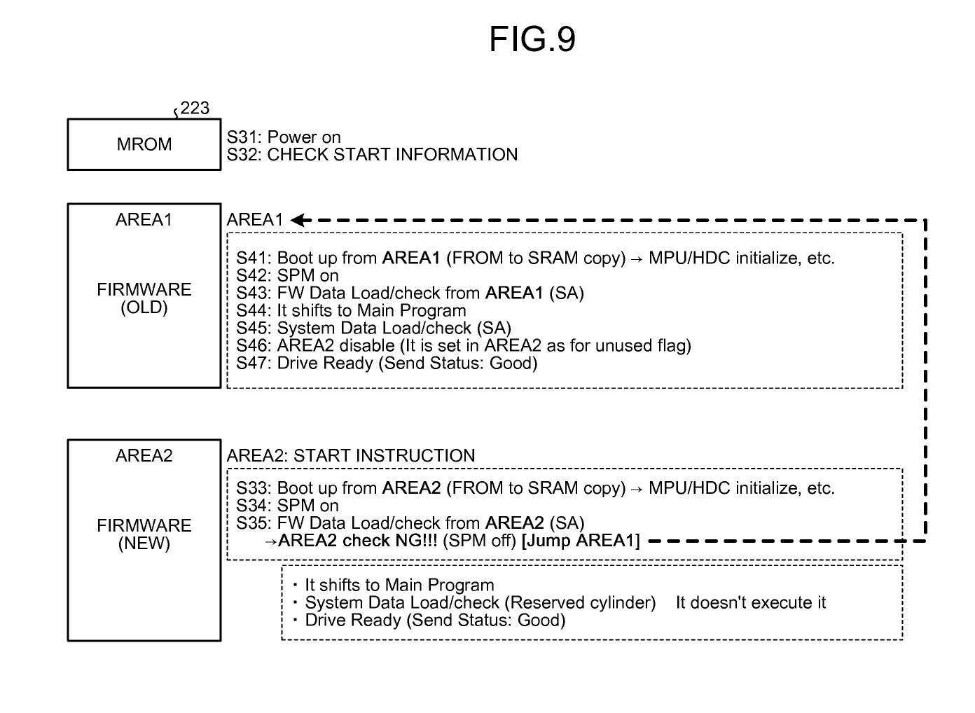

The switching processor 232 starts the storage device 1 using the firmware before rewrite by the rewrite processor 230, when abnormity is detected in the firmware where the rewrite is finally performed at the time of starting the storage device 1 by the start processor 231. An aspect where the firmware is switched by the switching processor 232 will now be described with reference to FIGS. 8 and 9. FIG. 8 illustrates an aspect where firmware is switched upon start of the storage device 1. FIG. 9 illustrates an aspect where firmware is switched during the start process of the storage device.

As illustrated in FIG. 8, when the newest firmware is stored in the Area2, the start processor 231 starts the storage device 1 at the side of the Area2, but it is assumed that abnormality is detected in the firmware of the side of the Area2. In this case, the switching processor 232 switches the firmware and starts the storage device 1 using the firmware belonging to the Area1.

Specifically, as illustrated in FIG. 9, when the start processor 231 checks the SA-side firmware 142b in the Area2 at S35, if abnormality is detected in the SA-side firmware 142b, the switching processor 232 switches the firmware to the firmware belonging to the Area1. When abnormality is detected in the firmware, the start processor 231 turns off the SPM. The start processor 231 performs the processes S41 to S47 using the firmware belonging to the Area1.

That is, the start processor 231 copies the FROM-side firmware 211a in the Area1 to the SRAM 222, and performs an initialization process on the MPU 224 or the HDC 220 (S41). Next, the start processor 231 turns on the SPM (S42), loads the SA-side firmware 142a in the Area1, and verifies validity of data (S43). If the validity of the data is confirmed, the start processor 231 moves to the main program (S44), loads the system data stored in the SA 140, and verifies validity of the system data (S45). If the validity of the system data is recognized, the start processor 231 sets a flag indicating that the Area2 is disabled (S46), and notifies the host apparatus of a message indicating that the start process is completed (S47).

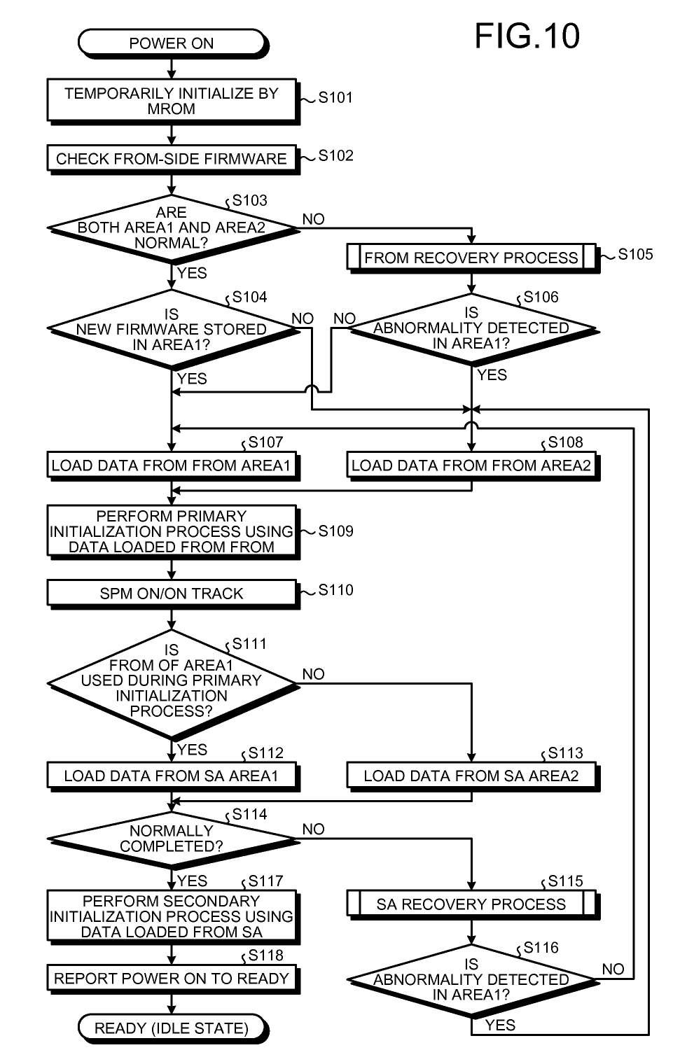

The operation of the storage device 1 of the embodiment will now be described. First, the start process according to the embodiment will be described with reference to FIG. 10. FIG. 10 is a flowchart of the start process according to the embodiment.

As illustrated in FIG. 10, when the storage device 1 is turned on, the start processor 231 performs temporary initialization using the MROM 223 (S101) and checks the FROM-side firmware 211a and 211b of the Area1 and the Area2 (S102). Next, the start processor 231 determines whether the FROM-side firmware 211a and 211b of the Area1 and the Area2 are normal (S103). When the FROM-side firmware 211a and 211b of the Area1 and the Area2 are normal (YES at S103), the process proceeds to S104.

At S104, the start processor 231 determines whether new firmware is stored in the Area1. This determination is made by comparing the start information 212a and 212b of the individual areas and determining whether a value of the start information 212a of the Area1 is larger than a value of the start information 212b of the Area2. When the new firmware is stored in the Area1 (YES at S104), the process proceeds to S107. Meanwhile, when the new firmware is not stored in the Area1 (NO at 5104), the process proceeds to S108.

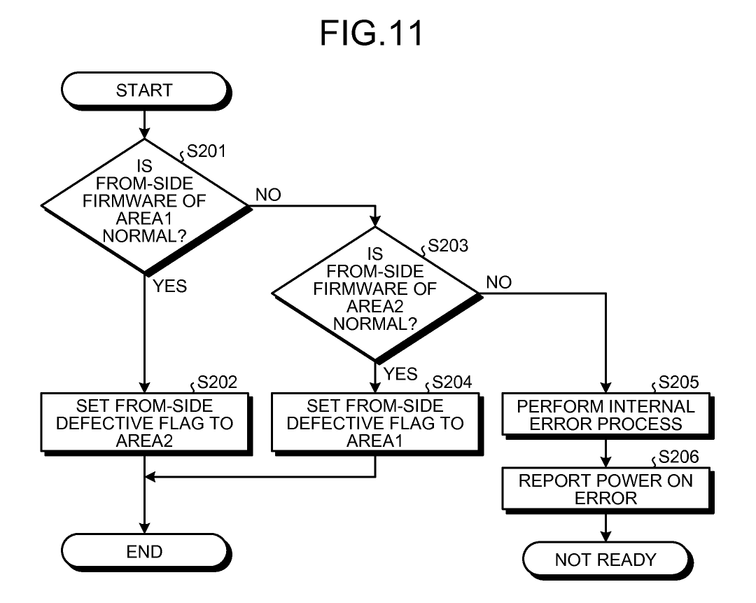

Meanwhile, at S103, when any of the FROM-side firmware 211a and 211b of the Area1 and the Area2 is not normal (NO at 5103), the switching processor 232 performs a FROM recovery process (S105). The FROM recovery process corresponds to the processes 5201 to 5206 in FIG. 11, which will be described in detail below.

If the process 5105 is completed, the switching processor 232 determines whether the firmware where the abnormality is detected is the FROM-side firmware 211a of the Area1 (S106). This determination is made based on whether a FROM-side defective flag to be described in detail below is set to the Area1. When the firmware where the abnormality is detected is not the FROM-side firmware 211a of the Area1 (NO at 5106), the process proceeds to S107. Meanwhile, when the firmware where the abnormality is detected is the FROM-side firmware 211a of the Area1 (YES at S106), the process proceeds to S108.

At S107, the start processor 231 loads data stored in the storage area 210a of the FROM 21 in the Area1. At S108, the start processor 231 loads data stored in the storage area 210b of the FROM 21 in the Area2. At S109, the start processor 231 performs a primary initialization process using the data loaded at S107 or S108.

Next, the start processor 231 turns on the SPM (S110), and determines whether the primary initialization process at S109 is performed using the storage area 210a of the FROM 21 in the Area1 (S111). When the primary initialization process is performed using the storage area 210a of the FROM 21 in the Area1 (YES at S111), the start processor 231 loads data stored in the storage area 141a of the SA140 in the Area1 (S112). Meanwhile, when the primary initialization process at S109 is not performed using the storage area 210a of the FROM 21 in the Area1 (NO at S111), the start processor 231 loads data stored in the storage area 141b of the SA 140 in the Area2 (S113).

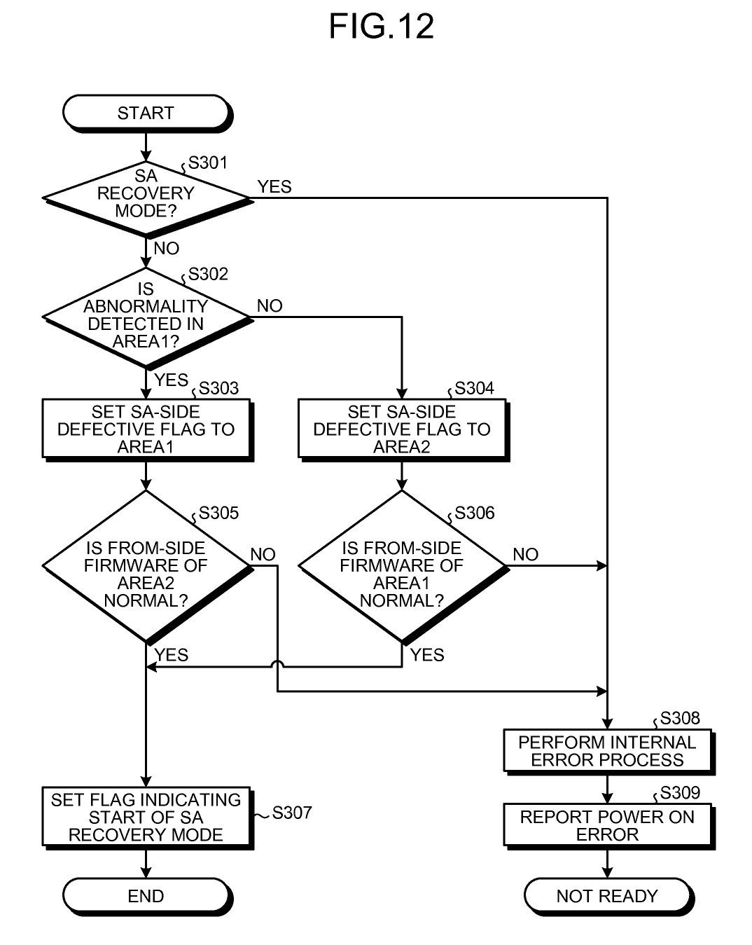

If the process S112 or S113 is completed, the start processor 231 determines whether the data loading of the SA 140 is normally completed (S114). When the data loading of the SA 140 is not normally completed (NO at S114), the switching processor 232 performs the SA recovery process (S115). The SA recovery process corresponds to the processes S301 to s309 in FIG. 12, which will be described in detail below.

If the process S115 is completed, the switching processor 232 determines whether the area where the abnormality is detected is the Area1 (S116). This determination is made based on whether an SA-side defective flag to be described in detail below is set to the Area1. When the area where the abnormality is detected is the Area1 (YES at S116), the process proceeds to S108. Meanwhile, when the area where the abnormality is detected is not the Area1 (NO at S116), the process proceeds to S107.

Meanwhile, at S114, when the data loading of the SA 140 is normally completed (YES at S114), the start processor 231 performs a secondary initialization process using the data loaded at S112 or S113 (S117). The start processor 231 reports a start preparation being completed to the host apparatus 2 (S118) and enters Ready state.

The FROM recovery process at S105 will now be described with reference to FIG. 11. FIG. 11 is a flowchart of the FROM recovery process according to the embodiment.

As illustrated in FIG. 11, if the FROM recovery process starts, the switching processor 232 determines whether the FROM-side firmware 211a of the Area1 is normal (S201). This determination is made based on whether abnormality is detected in the FROM-side firmware 211a of the Area1 at the process 5102 in FIG. 10. When the FROM-side firmware 211a of the Area1 is normal (YES at S201), the switching processor 232 sets the FROM-side defective flag to the predetermined area of the storage area 210b of the FROM 21 in the Area2 (S202).

Meanwhile, at S201, when the FROM-side firmware 211a of the Area1 is not normal (NO at S201), the switching processor 232 determines whether the FROM-side firmware 211b of the Area2 is normal (S203). This determination is made based on whether abnormality is detected in the FROM-side firmware 211b of the Area2 at S102 in FIG. 10. When the FROM-side firmware 211b of the Area2 is normal (YES at S203), the switching processor 232 sets the FROM-side defective flag to the predetermined area of the storage area 210a of the FROM 21 in the Area1 (S204).

Meanwhile, at S203, when the FROM-side firmware 211b of the Area2 is not normal (NO at S203), the switching processor 232 performs an internal error process (S205), reports, to the host apparatus 2, a message indicating that an error is generated in the start process of the storage device 1 (S206), and enters Not Ready state. Meanwhile, when the process S202 or S204 is completed, the switching processor 232 completes the FROM recovery process.

The SA recovery process at S115 will now be described with reference to FIG. 12. FIG. 12 is a flowchart of the SA recovery process according to the embodiment.

As illustrated in FIG. 12, if the SA-side recovery process starts, the switching processor 232 determines whether it is in SA recovery mode (S301). This determination is made based on whether a flag indicating a start of the SA recovery mode is set at the process 5307 to be described in detail below. When not in the SA recovery mode (NO at S301), the process proceeds to S302. Meanwhile, in the SA recovery mode, the process proceeds to S308.

At S302, the switching processor 232 determines whether the firmware where the abnormality is detected at S114 in FIG. 10 is the SA-side firmware 142a of the Area1. When the firmware where the abnormality is detected is the SA-side firmware 142a of the Area1 (YES at S302), the switching processor 232 sets the defective flag of the SA 140 to the predetermined area of the storage area 210a of the FROM 21 in the Area1 (S303), and the process proceeds to S305. When the firmware where the abnormality is detected is not the SA-side firmware 142a of the Area1 (NO at S302), the switching processor 232 sets the defective flag of the SA 140 to the predetermined area of the storage area 210b of the FROM 21 in the Area2 (S304), and the process proceeds to S306.

At S305, the switching processor 232 determines whether the FROM-side firmware 211b of the Area2 is normal. In this process, when the FROM-side firmware 211b of the Area2 is normal (YES at S305), the process proceeds to S307. When the FROM-side firmware 211b of the Area2 is not normal (NO at S305), the process proceeds to S308. At S306, the switching processor 232 determines whether the FROM-side firmware 211a of the Area1 is normal. When the FROM-side firmware 211a of the Area1 is normal (YES at S306), the process proceeds to S307. When the FROM-side firmware 211a of the Area1 is not normal (NO at S306), the process proceeds to S308.

At S307, the switching processor 232 sets the flag indicating the start of the SA recovery mode to the predetermined area in the FROM 21, and completes the SA recovery process. Meanwhile, at S308, the switching processor 232 performs an internal error process, reports, to the host apparatus 2, a message indicating that an error is generated in the start process of the storage device (S309), and enters Not Ready state.

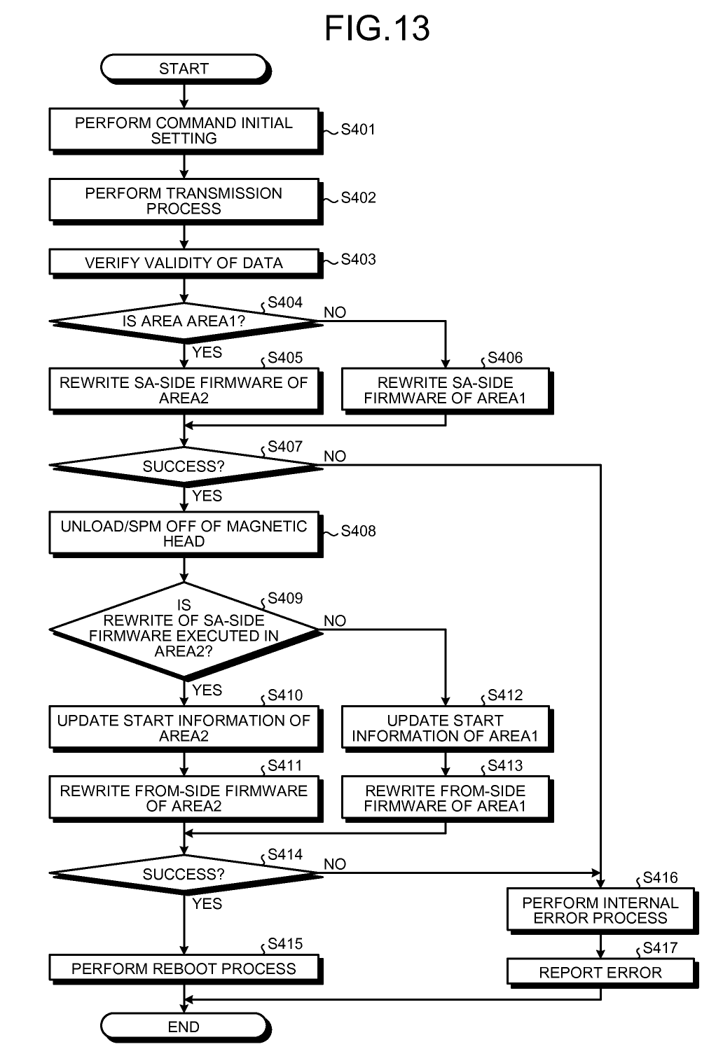

A firmware rewrite process according to the embodiment will now be described with reference to FIG. 13. FIG. 13 is a flowchart of the firmware rewrite process according to the embodiment.

If the rewrite processor 230 receives an update instruction of the firmware from the host apparatus 2, as illustrated in FIG. 13, the rewrite processor 230 performs initial setting of a command (S401), and performs a transmission process of firmware data from the host apparatus 2 (S402). Next, the rewrite processor 230 verifies validity of the acquired firmware data (S403), and determines whether the area that the currently executed firmware belongs is the Area1 (S404). When the area that the currently executed firmware belongs is the Area1 (YES at S404), the rewrite processor 230 rewrites the SA-side firmware 142a of the Area2 (S405). When the area that the currently executed firmware belongs is the Area2 (NO at S404), the rewrite processor 230 rewrites the SA-side firmware 142b of the Area1 (S406).

Next, the rewrite processor 230 determines whether the SA-side firmware is successfully rewritten (S407). When the SA-side firmware is successfully rewritten (YES at S407), the rewrite processor 230 unloads the magnetic head 12 and turns off the SPM (S408), and the process proceeds to S409. Meanwhile, when the SA-side firmware is not successfully rewritten (NO at S407), the process proceeds to S416.

At S409, the rewrite processor 230 determines whether the area where the SA-side firmware is rewritten is the Area2. When the area where the SA-side firmware is rewritten is the Area2 (YES at S409), the rewrite processor 230 updates the start information 212b of the Area2 (S410), and rewrites the FROM-side firmware 211b of the Area2 (S411). Meanwhile, when the area where the SA-side firmware is rewritten is not the Area2 (NO at S409), the rewrite processor 230 updates the start information 212a of the Area1 (S412), and rewrites the FROM-side firmware 211a of the Area1 (S413).

If the process S411 or S413 is completed, the rewrite processor 230 determines whether the FROM-side firmware is successfully rewritten (S414). When the FROM-side firmware is successfully rewritten (YES at S414), the rewrite processor 230 performs a reboot process (S415) and completes a firmware rewrite process. Meanwhile, when the FROM-side firmware is not successfully rewritten (NO at S414), the rewrite processor 230 performs an internal error process (S416), reports an error to the storage device (S417), and completes a firmware rewrite process.

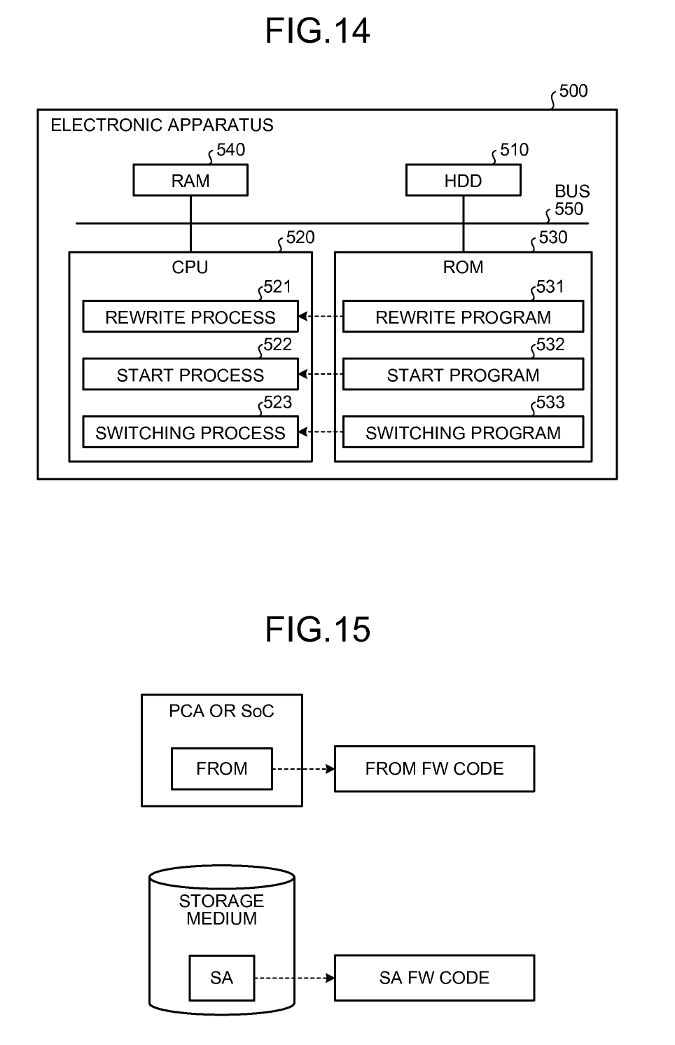

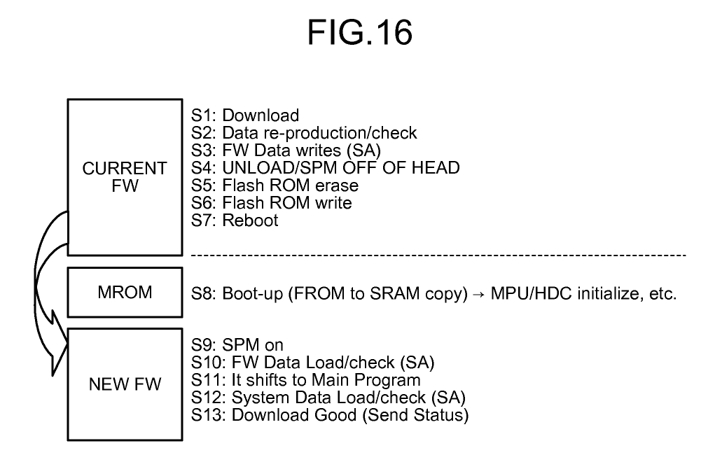

The various processes described in the embodiment may be realized by executing previously prepared programs on the electronic apparatus. Next, an example of the electronic apparatus that executes a computer program (hereinafter, “firmware management program”) that realizes the same functions as the storage device 1 of the embodiment will be described with reference to FIG. 14. FIG. 14 illustrates an electronic apparatus 500 that executes the firmware management program.

As illustrated in FIG. 14, the electronic apparatus 500 comprises an HDD 510, a CPU 520, a ROM 530, and a RAM 540, which are connected by a bus 550.

In the ROM 530, the firmware management program is previously stored. That is, as illustrated in FIG. 14, a rewrite program 531, a start program 532, and a switching program 533 are previously stored in the ROM 530.

When the CPU 520 reads the programs 531 to 533 from the ROM 530 and executes them, the programs 531 to 533 function as a rewrite process 521, a start process 522, and a switching process 523, respectively. The CPU 520 corresponds to the MPU 224 illustrated in FIG. 4.

The HDD 510 stores various data for use in the processes 521 to 523. The CPU 520 loads various data from the HDD 510 into the RAM 540 so that the data stored in the RAM 540 can be used in the processes 521 to 523 to implement, for example, the firmware rewrite process.

As described above, according to the embodiment, when firmware is rewritten, firmware being executed at the time of the rewrite is not rewritten. Therefore, even when the rewrite is failed, the firmware can be switched to the original firmware that is not rewritten and thereby the storage device can be started. Even if rewrite is performed again after the rewrite is failed, the firmware being executed at the time of the rewrite is not rewritten. Therefore, the start of the storage device can be prevented from being disabled due to several rewrite failures. Therefore, according to the embodiment, it is possible to reliably prevent the start disabled state due to the rewrite failure of the firmware.

According to the embodiment, since the start disabled state due to the rewrite failure of the firmware can be prevented without the hardware configuration, such as a timer or a switching circuit, a manufacturing cost can be reduced.

The embodiment is susceptible to several modifications and variations.

For example, after firmware is rewritten, when it is confirmed that the storage device 1 can be started by executing the new firmware (i.e., when it is confirmed that the firmware is successfully rewritten), the start processor 231 may erase firmware other than the new firmware. With this, upon the next firmware rewrite, the rewrite processor 230 can omit the erase process of the FROM-side firmware 211, resulting in less time required for the firmware rewrite process. Further, it can be confirmed whether the storage device 1 can be started by executing the new firmware, for example, by checking that the data loading of the SA 140 has been normally completed at S114 of FIG. 10.

In the embodiment, even when the abnormality is detected in the newest firmware, the start information 212 is not changed. For this reason, in the embodiment, when abnormality is detected in the newest firmware, the processes are performed such that start using the newest firmware→detection of the abnormality of the newest firmware→start using the old firmware, each time the storage device 1 is started. However, when abnormity is detected in the newest firmware, the start information 212 of the firmware may be changed. The start information 212 may be changed in such a manner, for example, that the start information 212 of the newest firmware where the abnormality is detected may be switched to the start information 212 of the old firmware switched by the switching processor 232. Further, the start information 212 may be updated through increment by even numbers (for example, the start information is updated like “2”→“4”→“6”→“8”, each time firmware is rewritten). The value of the start information 212 of the firmware may be decreased by 1 when abnormality is detected in the firmware. When the start information 212 indicating the maximum value is an odd number upon starting the storage device 1, the start processor 231 may start the storage device 1 using the firmware corresponding to the start information 212 indicating a value smaller than the maximum value by 1.

In the embodiment, the start information 212 is represented by the rewrite count of the firmware, but may be represented by a flag indicating that the rewrite is performed last. In this case, however, when updating the start information, the rewrite processor 230 needs to update the start information of the area where the rewrite of the firmware is not performed as well as the start information of the area where the rewrite of the firmware is performed.

In the embodiment, firmware to be used to start the storage device 1 is determined based on the start information 212. However, firmware to be used to start the storage device 1 may be selected by the user. With this, even when firmware of a plurality of generations are evaluated and verified, the firmware rewrite process does not need to be performed every time, and the Not Ready state due to the rewrite can be suppressed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer program product comprising a computer-readable medium having stored thereon a computer program for managing firmware stored in an electronic apparatus that, when executed, causes a computer to:
rewrite at least one firmware item other than a firmware item being executed among a plurality of firmware items in the electronic apparatus with a new firmware item;
boot the electronic apparatus with one of the plurality of firmware items; and
switch the firmware item for booting to another firmware item when anomaly is detected in the firmware item while booting the electronic apparatus.

2. The computer program product of claim 1, further comprising the computer program causes the processors to:
store information on a rewrite count of the firmware item until the rewriting is completed in a predetermined storage area in association with the firmware item rewritten when rewriting of the firmware item is completed; and
boot the electronic apparatus with the firmware item associated with information on the rewrite count indicating a substantially maximum value.

3. The computer program product of claim 2, further comprising the computer program causes the processors to:
erase a firmware item other than the firmware item associated with the information on the rewrite count indicating the substantially maximum value when it is confirmed that the electronic apparatus is configured to boot with the firmware item.

4. A storage device comprising:
a plurality of storage modules configured to store a plurality of firmware items;
a rewrite module configured to rewrite at least one of the firmware items other than a firmware item being executed with a new firmware item;
a boot module configured to boot the storage device with one of the firmware items; and
a switch configured to switch the firmware item to another firmware item when an anomaly is detected in the firmware item.

5. The storage device of claim 4, wherein
the rewrite module is configured to store information on a rewrite count of the firmware item until the rewriting is completed in a predetermined storage area in association with the firmware item rewritten when rewrite of the firmware item is completed, and
the boot module is configured to boot the storage device with the firmware item associated with information on a rewrite count indicating a substantially maximum value.

6. The storage device of claim 5, wherein the boot module is configured to erase a firmware item other than the firmware item when it is confirmed that the storage device is configured to boot with the firmware item associated with the information on the rewrite count indicating the substantially maximum value.

7. A firmware management method comprising:
rewriting at least one firmware item other than a firmware item being executed among a plurality of firmware items stored in an electronic apparatus with a new firmware item;
booting the electronic apparatus with one of the firmware items; and
switching the firmware item to another firmware item when an anomaly is detected in the firmware item.
